(19) United States
(12) Patent Application Publication
(10) Pub. No.: US 2009/0081468 A1
(43) Pub. Date: Mar. 26, 2009

(54) Reactive aromatic oils with improved adhesive properties

(75) Inventor: Christopher Mortensen, Bloomsbury, NJ (US)

Correspondence Address: MORGAN, LEWIS & BOCKIUS LLP, 1701 MARKET STREET, PHILADELPHIA, PA, 19103-2921, US

(73) Assignee: Crowley Chemical Company, New York, NY (US)

(21) Appl. No.: 12/221,726

(22) Filed: Aug. 6, 2008

Related U.S. Application Data
(60) Provisional application No. 60/963,610, filed on Aug. 6, 2007.

(51) Int. Cl. B32B 27/06

(52) U.S. Cl. 428/423.3; 106/200.3

(57) ABSTRACT

The invention encompasses compositions with improved adhesive properties and methods of use and manufacture thereof. In particular, the addition of one or more triols to adhesive compositions improved the tensile properties over straight, commercial available pMDI, while also improving cure kinetics.

### FIELD OF THE INVENTION

This invention relates to compositions with improved adhesive properties and methods of use and manufacture thereof. In particular, the addition of one or more polyols (e.g., a triol) to adhesive compositions improved the tensile properties over straight, commercial available pMDI, while also improving cure kinetics.

### BACKGROUND OF THE INVENTION

Solid lumber usually has growth defects such as large knots. These knots come from the growth of branches in the stem of the tree. Knots limit the bending or tensile strength of wood by changing the direction of the wood cells with respect to the axis of the board. The effect to knots on the tension of solid wood is similar to the effect of drilling holes the size of knots in the board.

The procedure of processing wood into smaller components and recomposing it into a product that may perform better than solid wood is an important way to engineer the properties of the product. The common element in any wood composite is wood fiber. Wood composites are made with balanced construction to maintain symmetry and avoid warping under changing moisture and temperature conditions.

Since wood composites are engineered materials they are designed to have specific performance advantages over solid wood products. A composite wood product must maintain minimum mechanical properties through its expected life. There are certain requirements fro dimensional stability in thickness, length or width for many composite panel and lumber products. Design loads are determined for engineered wood products; these must be met and exceeded in order to have a product that performs acceptably. Failure of an adhesive bond can be classified as adherent failure, adhesive failure, or cohesive failure.

The construction industry has been using more adhesives than other wood product industries for decades. Adhesives are substances that can hold materials together at the surfaces. Adhesion is an attractive phenomenon between two material surfaces. Strength and stiffness of wood composites are attributed to the efficient transfer of stress from wood fiber to adhesive, and back to wood.

In order for the adhesive and wood to come close enough for intimate contact, adhesives must be liquid and must wet the surface. A surface-wetting liquid is one that spreads easily over and into pores of the surface and readily flows into capillaries. The flow of adhesive into contours of the wood surface increases surface area and opportunity for interactions between adhesive and substrate.

Structural adhesives are those that contribute to the integrity and stiffness of a structure for as long as it is in use. The function of adhesives in keeping a building intact impacts the safety of its inhabitants. Plywood and exterior grade oriented strandboard (OSB) are wood composites made with structural adhesives such as phenol-formaldehyde or isocyanates. These adhesives are capable of maintaining adequate levels or performance after long-term exposure to water soaking and drying.

Polymeric methylene diphenyl diisocyanate (PMDI) is a cross linking thermoset. The isocyanate starts out as a monomeric, low viscosity, polar liquid. The liquid readily wets wood surface, and the small molecular weight facilitates deep penetration of the adhesive into the wood material. pMDI resins cure by reacting with the water in the wood and creating urea linkages, which creates rigid, polar networks. This adhesive network has been shown to create urethane linkages with molecules in the wood. This is an important contributor to the properties of adhesion or isocyanates.

The current inventors have developed novel compositions and processes for increasing the adhesive properties of the pMDI adhesives.

### SUMMARY OF THE INVENTION

The invention encompasses compositions having improved bonding capabilities in composite materials. It has surprisingly been found that the addition of a polyol, and in certain embodiments a triol, improved the tensile properties of the composition over straight, commercially available pMDI by multiples while also improving cure kinetics. Specifically, the compositions and methods achieve indexes of 22 to 36. It was thus surprisingly found that the addition of a polyol results in adhesive properties in much greater proportion to what would normally be expected.

Accordingly, in one embodiment, the invention encompasses a composition containing a polyisocyanate, an oil, and a polyol.

In another embodiment, the invention encompasses a method of making a composite panel material using the adhesive compositions of the invention. In a particular embodiment, the composite material is oriented strand board or timber strand, which is structural or load bearing, engineered paneling. In another embodiment, the wood used in the composite material is Aspen, Southern Yellow Pine, Oak, or combinations thereof. However, one of ordinary skill in the are will recognize that all woods currently used in the OSB process can be used in the methods of the invention. In a preferred embodiment, the invention encompasses a process for the production of composite materials comprising A) combining wood particles with an adhesive binder composition of the invention, and B) molding or compressing the combination of wood particles and the binder composition formed in A). In certain embodiments, the compressing or molding typically occurs at pressures of from about 200 to 1000 psi (preferably 300 to 700 psi) for about 2 to 10 (preferably 4 to 8) minutes at temperatures of from about 120° F. to 225° F., 220° F. The preferred curing conditions were an attempt to replicate the press conditions seen at the mill; 220° F. for 1, 2, 4 and 6 hours.

### DETAILED DESCRIPTION OF THE INVENTION

The invention encompasses a binder or adhesive composition. In certain embodiments the binder is a binder for cellulosic materials. Embodiments of the invention typically include: A. an organic polyisocyanate; B. an aromatic oil; and, C. a polyol. Embodiments may also include other additives, as explained below. In a preferred embodiment, the polyisocyanate is pMDI. In another preferred embodiment, the aromatic oil is Viplex 222. In another preferred embodiment, the polyol is a triol, preferably Arcol F3022.

The invention also encompasses a method for the preparation of a synthetic composite wood, wherein cellulosic wood is contacted with a binder and the treated material is subsequently formed into boards by the application of heat and pressure, wherein the binder includes a polyisocyanates, an aromatic oil, and polyol.

Another embodiment of the invention encompasses a synthetic board comprising cellulosic material bonded together with a binder including a polyisocyanate, an aromatic oil, and a polyester polyol. In one embodiment, the cellulosic material is bonded together to form a member selected from the group consisting of a particleboard, a waferboard, an oriented waferboard and an oriented strand board.

Another embodiment of the invention encompasses a multilayered synthetic board comprising cellulosic material bonded together with an adhesive resin, wherein the core of the board is bonded together with the binder described herein.

The preceding embodiments and the constituents thereof are described hereafter.

A. Polyisocyanates of the Invention

Both aliphatic and aromatic polyisocyanates can be used in the compositions and methods of the invention.

In one embodiment, the polyisocyanate is 1,4-tetramethylene diisocyanate.

In another embodiment, the polyisocyanate is 1,6-hexamethylene diisocyanate.

In another embodiment, the polyisocyanate is 1,12-dodecane diisocyanate.

In another embodiment, the polyisocyanate is cyclobutane-1,3-diisocyanate.

In another embodiment, the polyisocyanate is cyclohexane-1,3- and 1,4-diisocyanate.

In another embodiment, the polyisocyanate is 1,5-diisocyanato-3,3,5-trimethylcyclohexane.

In another embodiment, the polyisocyanate is hydrogenated 2,4- and/or 4,4′-diphenylmethane diisocyanate (H₁₂MDI).

In another embodiment, the polyisocyanate is isophorone diisocyanate.

In another embodiment, the polyisocyanate is 2,4-toluene diisocyanate (TDI).

In another embodiment, the polyisocyanate is 2,6-toluene diisocyanate (TDI).

In another embodiment, the polyisocyanate is 1,3- and 1,4-phenylene diisocyanate.

In another embodiment, the polyisocyanate is 4,4′-diphenylmethane diisocyanate (including mixtures thereof with minor quantities of the 2,4′-isomer) (MDI).

In another embodiment, the polyisocyanate is 1,5-naphthylene diisocyanate.

In another embodiment, the polyisocyanate is triphenylmethane-4,4′,4″-triisocyanate.

In another embodiment, the polyisocyanate is polyphenylpolymethylene polyisocyanates (pMDI).

Examples of suitable aliphatic polyisocyanates include 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4- and/or 4,4′-diphenylmethane diisocyanate (H₁₂MDI), isophorone diisocyanate, and the like.

Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (pMDI), and the like. In one embodiment, the preferred polyisocyanate is pMDI. Derivatives and prepolymers of the foregoing polyisocyanates, such as those containing urethane, carbodiimide, allophanate, isocyanurate, acylated urea, biuret, ester, and similar groups, may be used as well.

In one embodiment, the polyisocyanate is selected from the group consisting of 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4- and/or 4,4′-diphenylmethane diisocyanate (H₁₂MDI), isophorone diisocyanate, and the like. Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (pMDI), and the like. In one embodiment, the preferred polyisocyanate is pMDI. In a particular embodiment, the polyisocyanate is pMDI.

The amount of polyisocyanate preferably is sufficient to provide an isocyanate index of about 10 to about 100, preferably about 15 to about 70, and, more preferably from about 20 to about 40. As used herein the term “isocyanate index” refers to a measure of the stoichiometric balance between the equivalents of isocyanate used to the total equivalents of water, polyols and other reactants. An index of 100 means enough isocyanate is provided to react with all compounds containing active hydrogen atoms.

In further embodiments, the polyisocyanates of the present invention have a functionality of from about 2.1 to about 3.5, preferably 2.3 to 3.0 and most preferably of 2.6 to 2.8, and an NCO group content of about 30% to about 33%, preferably about 30.5% to about 32.5%, and a monomer content of from about 30% to about 90% by weight, preferably from about 40% to about 70%, wherein the content of monomer comprises up to about 5% by weight of the 2,2′-isomer, from about 1 to about 20% by weight of the 2,4′-isomer, and from about 25 to about 65% by weight of the 4,4′-isomer, based on the entire weight of the polyisocyanate. The polymeric MDI content of these isocyanates varies from about 10 to about 70% by weight, preferably from about 30% to about 60% by weight, based on the entire weight of the polyisocyanate.

In another embodiment, suitable polyisocyanates for component (1)(a) of the present invention also include, for example, mixtures of polyisocyanate blends as described above with adducts of MDI including, for example, allophanates of MDI as described in, for example, U.S. Pat. Nos. 5,319,053, 5,319,054 and 5,440,003, the disclosures of which are herein incorporated by reference, and carbodiimides of MDI as described in, for example, U.S. Pat. Nos. 2,853,473; 2,941,966; 3,152,162; 4,088,665; 4,294,719 and 4,244,855, the disclosures of which are herein incorporated by reference.

Polymeric isocyanates prepared from residues of the toluene diisocyanate production process may optionally be included in the binder composition of the present invention. Such residues are described, for example, in U.S. Pat. No. 5,349,082, the disclosure of which is herein incorporated by reference.

It should be noted that suitable binder compositions for the present invention typically include from 50 to 95% by weight, preferably from 50 to 80% by weight, and more preferably from 60 to 75% by weight, based on 100% by weight of the total of constituents A, B and C.

B. Aromatic Oils of the Invention

The present invention also includes a liquid hydrophobic diluent, such as an oil. The oils that are used in the compositions of the invention can be any suitable aromatic oil, substituted condensed ring or fused aromatic oils or bi-phenyl or substituted napthenic compounds with an initial boiling point of about 600 to about 1000 degrees Fahrenheit.

Illustrative examples of suitable oils include, but are not limited to, compounds such as, for example, Viplex 885, a petroleum distillate blend, and Viplex 222. Other Viplex compounds include: Viplex 5, 110, 525, 895BL, 224, 223, 226, 530A, 222HV, 225UHV, and Vycel U, which are commercially available from Crowley Chemical Corporation as an aromatic hydrocarbon oil that it typically used as a processing oil.

In another embodiment, the aromatic oil is selected from the group consisting of Viplex 885, and Viplex 222, and mixtures thereof.

In another embodiment, the aromatic oil is Viplex 222.

In another embodiment, the aromatic oil is selected from the group consisting of ARCOL F3040, ARCOL F3022, And ARCOL 3222, PLURACOL 1385 And PLURACOL 1388, VORANOL 3322, VORANOL 3010, VORANOL 3136, And VORANOL 3512A, and mixtures thereof.

It should be noted that suitable binder compositions for the present invention typically include from 5 to 50% by weight, preferably from 20 to 50% by weight, and more preferably from 25 to 40% by weight, based on 100% by weight of the total of constituents A, B and C.

C. Polyols of the Invention

In some embodiments, the polyol is a triol. As used herein, the term “triol” refers to a polyol that has an average of about 2.7 to about 3.1 hydroxyl groups per molecule. In a specific embodiment, the triol has a weight average molecular weight (Mw) of about 3000 grams/mole to about 3500 grams/mole. Representative examples of commercially available petroleum-derived triols include those available under the trade designations ARCOL F3040, ARCOL F3022, and ARCOL 3222 (from Bayer), PLURACOL 1385 and PLURACOL 1388 (from BASF), VORANOL 3322, VORANOL 3010, VORANOL 3136, and VORANOL 3512A (from Dow).

In another embodiment, the polyol is Arcol F3022.

It should be noted that suitable binder compositions for the present invention typically include one or more polyols at about 1 to 50% by weight. In other embodiments, a polyol is present at about 0.01 to 20% by weight, and preferably from 1% to 15% by weight. In certain embodiments, the binder composition includes a polyol at 5% to 25% of the total of constituents A, B and C. In certain other embodiments, a polyol is present at about 10% by weight.

D. Additional Additives

Suitable additives can be used in the resin for coating the raw wood components. Thus, from 0.25 to 3% by weight, based on the weight of the oven dry wood of the board product, of molten slack wax as well as emulsified wax can be used. Still further, from 5% to 20% by weight, based on the weight of the oven dry wood in the board product, of a suitable plasticizer may be included. Suitable plasticizers include glycol esters, glycerine esters, phosphate esters and the like.

Thickeners such as the various gums, starches, protein materials and clays may be used together with the resins. The resins can have additives dissolved therein. Illustratively urea is often dissolved in the resin in order to decrease the resin viscosity. When urea is used, its quantity can vary over a broad range such as from about 0.2% to 18% based on the weight of the resin solution containing the urea, preferably from about 2% to 14% thereof and particularly from about 8 to 12% thereof. In addition to reducing viscosity, the urea also acts as a formaldehyde scavenger for the resin.

Anti-foam agents can also be helpful for use in the manufacture of the resins of this invention. Illustrative of such anti-foam agents there can be mentioned silicone anti-foam agent designated as Q2-3183A of Dow-Corning of Midland Mich.; and Colloid 581 B and Colloid 999 which are products of Rhone-Poulanc having an office at Prospect Plains Road, Cranberry, N.J. 08512-7500. When anti-foam agents are used the quantity thereof will vary from about 0.001% to 0.3%, depending on the type of anti-foam agent used, preferably about 0.001 to 0.1% and particularly about 0.002 to 0.05% based on the weight of aqueous resin including the anti-foam agent. Smaller quantities of anti-foam agent are used with the more efficient anti-foam agents such as the silicones.

Apart from the small quantities of anti-foam agents, other emulsifiers are preferably avoided since they adversely affect the resin moisture responses and bonding properties. Thus, the compositions of this invention will preferably be substantially free of emulsifiers. By substantially free we mean the use of no more than about 1%, preferably no more than about 0.5% and particularly no more than about 0.2% based on the weight of the resin, including the emulsifier. Other components such as fillers and/or extenders may also be added to the resole resins of this invention.

In certain embodiments, the curing rate of the resin may be accelerated by contacting the resin or wood components with a curing agent. The curing agent may be a conventional curing accelerator such as a carboxylic acid ester, a lactone, an organic carbonate or a resorcinol-glutaraldehyde resin such as is disclosed in U.S. Pat. No. 5,498,647 of Mar. 12, 1996 to D. Shiau et al. The amount of curing agent can vary over a wide range such as that of about 1% to 20% of the resin solids.

E. Formation of a Binder of the Invention

Although the constituents of the invention can be mixed in any order, in certain embodiments, the order of the steps of mixing constituents A, B, and C (and optionally other constituents) may be important. In such embodiments, an in-situ urethane polymerization forming a high performance polyisocyanate/aromatic oil/polyol based wood binder adhesive can be developed.

Accordingly, in one embodiment, the invention encompasses a method of making an adhesive binder wherein a polyol, preferably a triol, is first added to an aromatic oil. The mixture is then added to a polyisocyanate (e.g., pMDI).

F. Application of Binder

As is conventional in the art, the adhesive, i.e. binder together with any additives, is applied to wood product fibers, flakes, chips, strands and the like by various spraying techniques whereas it is generally applied to veneers by coaters. The adhesive applied to the wood components is referred to herein as a coating even though it may be in the form of small resin particles such as atomized particles which do not form a continuous coating.

The range of resin solids in the resole resin before curing which are applied to the wood components can vary from about 1% to 15% and preferably 2% to 8% by weight of the wood components on dry finished panel weight depending of the quality of the panel product desired.

Hot pressing conditions for the panels utilizing the resinous adhesive of this invention will depend on the thickness of the board, the type of board, as well as on the resin characteristics. Generally, the platen temperatures can vary from about 240° F. (115° C.) to 450° F. (232° C.) with applied pressures which can range up to about 1200 psi for about 2 to 10 minutes.

In certain embodiments, the kinetics of the adhesive reaction at 220° F. appears to be immediate.

In one embodiment, the polyisocyanate is applied to the cellulosic material prior to application of a polyol or a polyol/aromatic oil mixture.

F. The Material Components

The basic raw materials for composites (e.g., a wood-product laminate) which can be made with the adhesives of this invention may be derived from various sources. For example, wood components in the form of wood fibers, chips, shavings, strands, flakes, particles and veneers. These materials which are used to prepare the laminated composites are referred to generally herein as wood components. The manufactured products include hardboard, particleboard, fiberboard, waferboard, strand-board and the like as well as plywood, and LVL. The internal bond strength of these products will be at least about 30 pounds per square inch (psi). Other materials beyond wood can also be used.

In accordance with the present invention, wood particles are combined with from about 1.5 to about 7%, preferably 2 to 6% by weight, based on the total weight of the wood composite, of the binder compositions as described above.

Methods for making plywood, cellulosic board, oriented strand-board (OSB) and the like are described in prior art as for instance in U.S. Pat. Nos. 4,758,478 to Daisy et al and 4,961,795 to Detlefsen et al., which patents are incorporated herein by reference in their entirety. For example, when producing a composition panel such as particle board or oriented strand-board by a mat process, wood flakes, strands or particles can be sprayed with a solution of the resin of this invention. The sprayed pieces of wood components may be passed through a forming head to make a mat. Hot pressing conditions for the mat will depend upon the target thickness for the board product as well as on the characteristic of the binder.

This invention is particularly useful in the manufacture of plywood and oriented strand-board. Plywood is composed of a multiple layer of wood veneers. The veneers are usually arranged so that the wood grain direction is perpendicular in adjacent veneers.

The plywood process requires straight logs cut to length, and conditioned in heated vats containing water and surfactants to increase the heating efficiency of the vats. The heated logs are then “peeled” wherein a veneer of predetermined thickness is removed continuously until the log diameter is reduced to a certain point, usually 5-8 inches (12.7-20.3 cm.) The veneer is than clipped into strips, sorted and dried to a moisture content of 15% or less.

After drying, the veneers are graded and assembled into plywood panels. The adhesive is applied to the veneers at this stage of manufacture. The adhesive is usually composed of the liquid resin and fillers that include inorganic and organic flours, such as wheat flours, wood flours, and clays. The adhesives are specially formulated for individual user mills depending on manufacturing equipment, type of wood to be glued, type of product to be made, and ambient environment conditions at the time of panel manufacture. The adhesive is usually applied to the veneers by roll coater, curtain coater, sprayline or foam extruder. The adhesive usually contains the resin at a level of 20% to 40% resin solids by weight. The adhesive is normally used with spread levels of 50 pounds to 55 pounds (27.2-25 Kg) when spread on one side.

After the adhesive is applied to the wood veneers and the panels are assembled, they are consolidated under heat and pressure. This is usually done in a steam hot press using platen temperatures of about 240-350° F. (115-176.5° C.) and pressures of 74-250 pound per square inch (5.2-17.6 Kg/sq cm)

Oriented strand-board or OSB is manufactured by orienting wood strands to increase strength and stability whereas waferboard consists of flakes randomly oriented and pressed into panels. Oriented strand-board uses wood strands longer than they are wide, which makes it possible to orient them in a specific direction. Placement and orientation is accomplished mechanically, generally through the use of a forming machine. Typically, OSB panels have 3 or 5 layers. To optimize panel stiffness, top and bottom layers of the panels have strands oriented length-wise. Strands in the core layer are oriented randomly or in some cases perpendicular to the face orientation. This orientation strategy increases panel stiffness, strength, and dimensional stability. Typical OSB process stages are as follows: (a) logs are delivered; (b) logs are stored in woodyard; (c) logs are soaked in heated vats; (c) logs are debarked; (d) logs are flaked into strands and dried to a moisture content of about 1 to 15%; (e) screens are used to remove fines; (f) strands are blended with resin and wax with the quantity of resin typically being about 2 to 5.5% and the quantity of wax being from about 0.5 to 2%, both based on the weight of the dried strands; (g) blended strands are dropped into a formline to orient the strands and form mats; (h) mats are pressed, typically for about 4 to 7 minutes at a temperature of about 240 to 450° F. (115-232° C.) into 23/32 inch thickness panels; (i) panels are cut to desired dimensions, stacked into units and then loaded onto trucks and shipped.

The most common thicknesses for the OSB panels vary from about 7/16 of an inch to 23/32 of an inch (1.1-1.8 cm). The dimensions of the strands used in making oriented strand-board typically vary from between a length of about 2.5 to 6 inches (0.4 to 15 cm), a thickness of about 0.025 to 0.15 inches (0.063-0.38 cm) and widths of about 1 to 4 inches (2.54-10.2 cm). However, the strand dimensions can vary depending on the contemplated end use of the product. Thus, for some applications strands are as much as 12 inches (30.5 cm) long.

The invention will be demonstrated by the following examples. In these examples and elsewhere through the specification, parts and percentages are by weight unless expressly indicated otherwise. Unless indicated otherwise, the quantity of the aliphatic hydrocarbylphenol is expressed as a percentage based on the weight of the aqueous, alkaline phenolic resoles resin. The aqueous alkaline phenolic resole resin, also simply referred to as the resin or resin solution, includes all of the ingredients in the resin such as water, any free phenol or formaldehyde, polymerized phenol-formaldehyde, alkalizing agent and the hydrocarbylphenol, the phenol-formaldehyde-hydrocarbylphenol and urea when urea is part of the resin. Also, the term “resin solids” refers to pan solids according to an industry accepted test where one gram of resin is placed in an aluminum pan and heated in a forced air oven at 125° C. for one hour and 45 minutes.

The adhesive binders of the invention have various applications including, but not limited to, use in wood binders for OSB, use in wood binders to replace phenyl formaldehyde resins in plywood, particle board, medium density fiber (MDF) board, wheat straw based paneling, use in crumb rubber adhesive applications (e.g., running and field tracks), use in carpet underlayment rebonding application, and use in construction adhesives, generally described as “Gorilla” glue.

### EXAMPLES

The following examples illustrate liquid cleaning compositions of the described invention. Unless otherwise specified, all percentages are by weight. The exemplified compositions are illustrative only and do no limit the scope of the invention. Unless otherwise specified, the proportions in the examples and elsewhere in the specification are by weight. It will be understood by those of skill in the art that numerous and various modifications can be made without departing from the spirit of the present invention. Therefore, it should be clearly understood that the forms of the present invention described herein are illustrative only and are not intended to limit the scope of the invention.

Table I illustrates the calculated index of illustrative compositions of the invention.

TABLE 1

| | Calculated | Blend | cps Viscosity Build | | |
|---|---|---|---|---|---|
| Composition | Index | NCO | Initial | 24 hr. | 7 day |
| pMDI/Viplex 222/Arcol | 22 | 16.29% | 229 | 782 | 836 |
| F3022 - 50/40/10 | | | | | |
| pMDI/Viplex 222/Arcol | 36 | 10.29% | 218 | 872 | 888 |
| F3022 - 30/60/10 | | | | | |

Table 2 illustrates dry tensile adhesion reported in psi on an Albert Twing tester for illustrative compositions of the invention.

TABLE 2

| | Aspen | | Southern Pine | | Oak | |
|---|---|---|---|---|---|---|
| | Cure temperature 220° F. for | | | | | |
| Composition | 1 hr | 6 hr | 1 hr | 6 hr | 1 hr | 6 hr |
| pMDI/Viplex 222/Arcol | 202 psi | 273 psi | 208 psi | 226 psi | 350* psi | 350* psi |
| F3022 - 50/40/10 | | | | | | |
| pMDI/Viplex 222/Arcol | 127 psi | 270 psi | 188 psi | 214 psi | 302 psi | 342 psi |
| F3022 - 30/60/10 | | | | | | |

*350 psi is the highest number that can be measured on the Albert Twing tester

Table 3 illustrates property retention for wet tensile adhesion on Aspen reported in psi on an Albert Twing tester using a dry tensile as the control.

TABLE 3

| | Wet Tensile Adhesion (psi) |
|---|---|
| pMDI/222/F3022///50/40/10 | |
| Dry (control) | 230 |
| 16 hrs. water soaking | 183 |
| 2 hrs. boiling water | 148 |
| pMDI/222/F3022///30/60/10 | |
| Dry (control) | 176 |
| 16 hrs. water soaking | 44 |
| 2 hrs. boiling water | 61 |

All of the references cited herein and appended hereto, including patents, patent applications, literature publications, and the like, are hereby incorporated in their entireties by reference.

What is claimed is:

1. A method for the preparation of a synthetic composite wood, wherein cellulosic wood is contacted with a binder and the treated material is subsequently formed into boards by the application of heat and pressure, wherein the binder comprises a polyisocyanate, an aromatic oil, and a polyol, wherein the polyol and aromatic oil are first mixed together and then the mixture is added to the polyisocyanate.

2. The method of claim 1, wherein the polyisocyanate is selected from the group consisting of 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4- and/or 4,4′-diphenylmethane diisocyanate (H₁₂MDI), isophorone diisocyanate, polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (pMDI).

3. The method of claim 1, wherein the polyisocyanate is pMDI.

4. The method of claim 1, wherein the aromatic oil is selected from the group consisting of Viplex 885, and Viplex 222, and mixtures thereof.

5. The method of claim 1, wherein the aromatic oil is Viplex 222.

6. The method of claim 1, wherein the polyol is triol.

7. The method of claim 1, wherein the aromatic oil is selected from the group consisting of ARCOL F3040, ARCOL F3022, And ARCOL 3222, PLURACOL 1385 And PLURACOL 1388, VORANOL 3322, VORANOL 3010, VORANOL 3136, And VORANOL 3512A, and mixtures thereof.

8. The method of claim 1, wherein the polyol is Arcol F3022.

9. The method of claim 3 wherein the polyisocyanate is applied to the cellulosic material prior to application of the polyol.

10. A synthetic board comprising cellulosic material bonded together with a binder comprising a polyisocyanate, an aromatic oil, and a polyester polyol.

11. The synthetic board of claim 10, wherein the cellulosic material is bonded together to form a member selected from the group consisting of a particleboard, a waferboard, an oriented waferboard and an oriented strand board.

12. The synthetic board of claim 10, wherein the polyisocyanate is selected from the group consisting of 1,4-tetramethylene diisocyanate, 1,6-hexanethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4- and/or 4,4′-diphenylmethane diisocyanate (H₁₂MDI), isophorone diisocyanate, polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (pMDI).

13. The synthetic board of claim 10, wherein the polyisocyanate is pMDI.

14. The synthetic board of claim 10, wherein the aromatic oil is selected from the group consisting of Viplex 885, and Viplex 222, and mixtures thereof.

15. The synthetic board of claim 10, wherein the aromatic oil is Viplex 222.

16. The synthetic board of claim 10, wherein the polyol is triol.

17. The synthetic board of claim 10, wherein the aromatic oil is selected from the group consisting of ARCOL F3040, ARCOL F3022, And ARCOL 3222, PLURACOL 1385 And PLURACOL 1388, VORANOL 3322, VORANOL 3010, VORANOL 3136, And VORANOL 3512A, and mixtures thereof.

18. The synthetic board of claim 10, wherein the polyol is Arcol F3022.

19. A binder composition for cellulosic material comprising an organic polyisocyanate, an aromatic oil and an polyol.

20. The binder of claim 19, wherein the polyisocyanate is selected from the group consisting of 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4- and/or 4,4′-diphenylmethane diisocyanate (H₁₂MDI), isophorone diisocyanate, polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (pMDI), and mixtures thereof.

21. The binder of claim 19, wherein the polyisocyanate is pMDI.

22. The binder of claim 19, wherein the aromatic oil is selected from the group consisting of Viplex 885, and Viplex 222, and mixtures thereof.

23. The binder of claim 19, wherein the aromatic oil is Viplex 222.

24. The binder of claim 19, wherein the polyol is triol.

25. The binder of claim 19, wherein the aromatic oil is selected from the group consisting of ARCOL F3040, ARCOL F3022, And ARCOL 3222, PLURACOL 1385 And PLURACOL 1388, VORANOL 3322, VORANOL 3010, VORANOL 3136, And VORANOL 3512A, and mixtures thereof.

26. The binder of claim 19, wherein the polyol is Arcol F3022.

27. A multilayered synthetic board comprising cellulosic material bonded together with an adhesive resin, wherein the core of the board is bonded together with the binder of claim 19.
